(19) United States
(12) Patent Application Publication
(10) Pub. No.: US 2019/0157701 A1
(43) Pub. Date: May 23, 2019

(54) HIGH-ENERGY DENSITY FLOW BATTERY SYSTEM WITH A SMI-SOLID FLUID CONTAINING CHALCOGENS OR METAL CHALGOGENIDES

(71) Applicant: The Chinese University of Hong Kong, Shatin (CN)

(72) Inventors: YI-CHUN LU, Shatin (CN); Zhou Yucun, Shatin (CN)

(21) Appl. No.: 16/197,143

(22) Filed: Nov. 20, 2018

Related U.S. Application Data
(60) Provisional application No. 62/589,205, filed on Nov. 21, 2017.

(51) Int. Cl. H01M 8/18; H01M 10/052; H01M 4/04

(52) U.S. Cl. CPC H01M 8/188; B60L 11/1898; H01M 4/0404; H01M 10/052

(57) ABSTRACT

This invention provides semi-solid electrolytes for use in redox flow batteries that have improved energy density and flow fluid properties. The battery systems of this invention contain an ionically conductive fluid, with electrode active particles suspended in the fluid that contain one or more elemental chalcogens, one or more metal chalcogenides, or a combination thereof. The fluid is substantially free of electronically conductive particles other than the chalcogens and chalcogenides. The battery system can be built with a flowable system for one or both electrodes. Prototypes of this invention have over twenty times more energy production per mass compared with previous battery technology, and can be recharged in a matter of minutes.

### REFERENCE TO PREVIOUS APPLICATION

This application claims the priority benefit of U.S. provisional patent application 62/589,205, filed Nov. 21, 2017. The priority application is hereby incorporated herein by reference in its entirety for all purposes.

### FIELD OF THE INVENTION

This application comes within the general field of controlled electrical power storage and recovery. In particular, it provides components for a redox flow battery system with superior energy density.

### BACKGROUND

The ongoing technological advances in vehicle construction, factory operation, and home appliances increase society's demand for electrical power. This is incongruous with increasing concerns about the effect of carbon-based fuels. Enormous investments are being made to develop ways of obtaining sustainable energy with minimal environmental impact by harvesting power from natural energy sources—such as solar power, winds, and wave motion—and converting the natural energy sources to electrical power.

A major challenge in the development of natural energy sources is the intermittency of power supply: Solar power conversion doesn't work well at night, and wind power conversion doesn't work well on calm days. But people want to enjoy their air-conditioning on calm sultry evenings. Another roadblock for many applications is that the power source needs to be mobile: for example, in electrically powered motor vehicles. This means that it needs to be relatively small and self-contained. Current battery technology is simply not suited for long-term on-demand power supply at the level required to convert society away from its reliance on carbon-based fuels. Rechargeable batteries currently in commercial production are associated with high manufacturing costs, low energy densities, and poor power performance.

Previous publications on battery technology include the following: U.S. Pat. No. 6,376,123 (Polyplus Battery Company) refers to rechargeable positive electrodes. US 2010/0047671 A1 (Massachusetts Institute Of Technology) refers to high energy density redox flow device. US 2012.0135278 A1 (Tomohisa Yoshie) refers to a redox flow battery. US 2015/0214555 A1 (Polyplus Battery Company) refers to lithium sulfur batteries and electrolytes that contain sulfur cathodes. US 2011/0200848 A1 and US 2011/0189520 A1 (24M Technologies Inc.) refer to high energy density redox flow device. U.S. Pat. No. 9,583,779 (Chiang et al., Massachusetts Institute Of Technology) refers to metal sulfide electrodes and energy storage devices.

The invention described in the sections that follow provides semi-solid electrolytes and battery systems with much higher fluid flow properties and energy density. It represents a considerable advance over currently available technology.

### SUMMARY OF THE INVENTION

Flow electrochemical devices such as redox flow batteries are promising technologies for electric vehicle and large-scale electricity storage, owing to its design flexibility in decoupling power and energy capacity. However, current redox flow batteries have low energy density and high cost, which significantly decrease their utility to power moving vehicles or supply energy to large power-consuming installations.

This invention provides semi-solid electrolyte fluids with much higher energy density and flow fluid property than previous technology. The invention addresses key challenges in the semi-solid electrolyte including fluid uniformity, phase separation, flowability and energy density. The claimed technology effectively eliminates phase-separation issues in semi-solid electrolyte, and considerably increases the energy density compared with electrolytes in current use.

A typical composition of a semi-solid fluid according to this invention comprises an ionically conductive fluid, with electrode active particles suspended in the fluid that contain one or more elemental chalcogens, one or more metal chalcogenides, or a combination thereof. Suitable chalcogens are sulfur (S), selenium (Se), and tellurium (Te). Suitable chalcogenides have the chemical formula AₓB_{y}, as defined and exemplified in the sections that follow. The ionically conductive fluid often contains one or more metal salts as exemplified below. The electrode compositions, battery cells, and battery systems of this invention typically but do not necessarily include an ionically conductive fluid that is substantially free of any electronically conductive particles other than the chalcogens and the chalcogenides.

A battery cell according to this invention typically includes a positive electrode current collector, a negative electrode current collector, an ion permeable separator between the positive electrode collector and the negative electrode collector, and a semi-solid fluid containing chalcogen and/or chalcogenides between the separator and one of the two current collectors: usually between the positive electrode current collector and the separator, thereby configuring the flowable composition to serve as a positive electrode. If the battery cell is configured as a flow system, it is operably connected to a subsystem that can recirculate the flowable composition between the battery cell and a reservoir.

A battery system according to this invention typically includes a reaction region having a positive electrode current collector, an ion permeable separator between the positive electrode collector and the negative electrode, and a semi-solid fluid containing chalcogens or chalcogenides between the separator and the positive electrode current collector. The flowable composition is configured to undergo reduction in the reaction region, thereby serving as a positive electrode for the battery system. This is combined with a fluid circulating subsystem that includes a reservoir containing the flowable composition, a first conduit connecting the reservoir to the reaction region, a second conduit connecting the reservoir to the reaction region, and a pump. The fluid circulating subsystem is constructed and arranged so that the pump recirculates the flowable composition in the reservoir through the first conduit to the reaction region and back through the second conduit to the reservoir.

For a single flow system, the negative electrode is static, and may be made of a conductive metal such as lithium (Li). Alternatively, the negative electrode may be a negative electrolytic solution or suspension positioned between the separator and a negative electrode current conductor.

For a redox flow battery system where both electrodes recirculate, the system comprises a reaction region and a positive electrode fluid circulating subsystem as described above. In addition, it has a negative electrode fluid circulating subsystem that includes a second reservoir containing the negative electrolytic solution or suspension, at least two conduits connecting the reservoir to the reaction region, and a second pump situated to recirculate the second flowable composition between the second reservoir and the reaction region by way of the conduits. The negative electrolytic solution or suspension may contain an electroactive material, as described later in this disclosure. There may be a separate electroactive zone between the separator and the flowable composition, which optionally includes a porous material as described below.

The battery system can be configured such that reversal of the current will cause recharging of the battery cell or system. Depending on the implementation, the system may have an energy density of at least 1,000 W h/kg or at least 2,000 W h/L (calculated based on electrode materials).

To implement any of the battery systems according to this invention for powering a drivetrain in a locomotive vehicle, an electrical circuit is completed such that the battery system is electrically connected to an electric motor that powers the drivetrain such that discharge of the battery system powers the drivetrain, thereby causing the vehicle to locomote. To implement any of the battery systems according to this invention for storing electrical power for use in an energy grid, an electrical potential is applied to a battery system so as to recharge the battery system and store the electrical potential; and sequentially, alternately, or concurrently releasing the electrical potential from the battery system into the energy grid.

### DRAWINGS

FIG. 1 is a schematic illustration of a flow battery according to this invention with one flowable electrode.

FIG. 2 is a schematic illustration of a flow battery with two flowable electrodes.

FIGS. 3A and 3B are a representative plots of voltage as a function of time for a flow battery with sulfur particles suspended in the fluid of the positive electrode.

FIG. 4 is a representative plot of voltage as a function of time for a flow battery with selenium particles suspended in the fluid of the positive electrode.

FIG. 5 compares the energy storage and recharge capabilities of a battery system of this invention with other battery systems in current use.

### DETAILED DESCRIPTION

The technology described in this disclosure provides semi-solid electrolytes with much higher energy density and flow fluid property than all the existing methods. It achieves more than twenty times greater energy capacity when compared with the state-of-the-art redox flow batteries.

### Inadequacy of the Current State of the Art

Prior art redox flow batteries are inadequate because of low energy density and high cost, increasing the energy density and reducing the cost of flow electrochemical devices has been one of the major research efforts and has motivated several new design concepts.

The concept of semi-solid Li-ion flow batteries having solid intercalation materials in a carbon-percolating conducting network was proposed by Yet-Ming Chiang, et. al. in pre-grant publications US 2010/0047671 A1, US 2011/0200848 A1 and US 2011/0189520 A1. Compared with the theoretical energy density of Li-ion batteries, which is typically limited to ˜420 Wh kg⁻¹ or 1400 Wh L⁻¹, the theoretical energy density lithium-sulfur battery can be as high as ˜2500 Wh kg⁻¹ or 2800 Wh L⁻¹ (Y. Yang, G. Zheng, Y. Cui, Nanostructured sulfur cathodes, Chemical Society Reviews, 42 (2013) 3018-3032.). Flow batteries based on the sulfur containing electrodes have been proposed by Y. Yang, G. Zheng, Y. Cui, “A membrane-free lithium/polysulfide semi-liquid battery for large-scale energy storage,” Energy Environ. Sci., 6 (2013) 1552-1558; and in CN Patent Nos. 02956866, 102324550, 103682414, 103682414, and U.S. Pat. No. 9,583,779. However, the energy densities of such batteries are limited by the solubility of the polysulfides in the solvent and the cut-off voltages.

A limitation of existing flow batteries is that they have low energy density and low volumetric capacity. By way of example, the volumetric energy density of the all-vanadium flow battery is about 25 Wh L⁻¹.

Another limitation ensues from use of electronically conductive materials in the recirculating fluid. Normally used electronically conductive materials such as the carbon black particles, carbon nanotubes with high surface areas and/or small particle sizes occupy a high volume percent in the electrode composition, which significantly reduces the volumetric energy density of the flow battery. The high viscosity of the fluid containing the electronically conductive materials increase operating costs.

### FEATURES AND BENEFITS OF THIS INVENTION

This invention takes advantage of the high energy densities of the chalcogens sulfur (S), selenium (Se), and tellurium (Te), and/or metal chalcogenides made from them. It eliminates the need for other conductive materials in the fluid, and provides high-energy-density and low-cost energy storage.

Flow battery systems of this invention demonstrate superior properties in part because they are constructed with a flowable electrolyte composition that is substantially free of electronically conductive particles. This means that the volumetric percent of the electronically conductive particles is no more than 0.5 and possibly no more than 0.1 or 0.01 volume percent. Prior art devices generally include a percolating electronically conductive network that contains a large proportion of electronically conductive particles. For example, for the battery system described in U.S. Pat. No. 9,583,779, electronically conductive particles (carbon black particles) are included in the fluid to create a network that is needed to conduct electricity. The electronically conductive particles occupy a high volume percent in the electrode composition, which significantly reduces the volumetric energy density of the flow battery. Presence of the electronically conductive particles also means that the fluid has high viscosity, which complicates and compromises operation.

During development of the invention disclosed here, it was discovered that removing or leaving out the carbon or conductive additives creates a flowable composition that has a superior energy density. Flowable compositions according to this invention also have substantially lower viscosity. This has the benefit of receding the power needed to circulate the composition, improving system efficiency and reducing cost.

Depending on the implementation, the technology described in this disclosure can achieve more than 1000 Ah/L of capacity, which is twenty times of the commercial redox flow battery materials (50 Ah/L). This invention provides a smaller size of battery with much more energy, which significantly reduces the cost and is more suitable for use in high-energy electric vehicles.

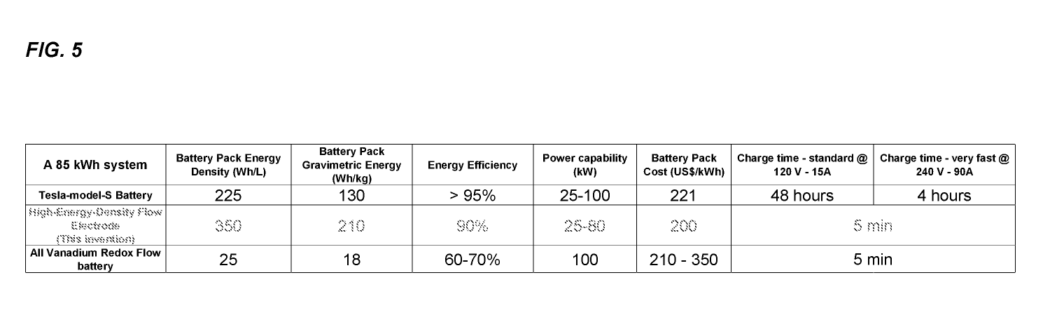

FIG. 5 shows a comparison of the energy storage capability of the battery systems of this invention with battery systems of the prior art. The energy density of the battery systems of this invention is at least as high as the battery in the Tesla model S. This is combined with the benefits of a rapid recharge time of low-powered vanadium redox flow batteries, since it is configured for recharge in a matter of minutes.

Redox Flow Battery with One Flowable Electrode

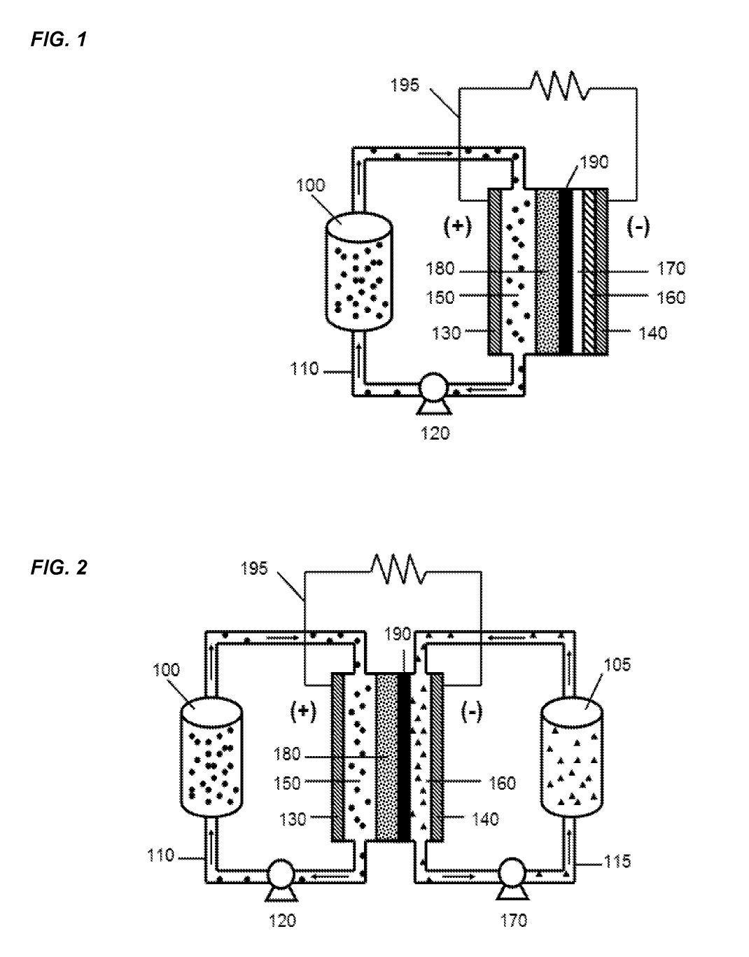

FIG. 1 is a non-limiting illustration of a flow battery according to this invention with one flowable electrode. A negative electrode current collector 140 and a positive electrode current collector 130 are separated by an ion-permeable separator 190. Flowable positive electrode is included, which comprises elemental chalcogens and/or metal chalcogenides electrode-active particles suspended in a semi-solid fluid. There are no other electronically conductive particles suspended in the fluid 150. The fluid space in the battery cell is connected to a storage tank 100 via conduit 110 and a transporting device 120. The static negative electrode 160 is in electronic communication with a negative electrode current collector 140 and a negative liquid electrolyte 170. Current collectors 130 and 140 are electronically connected via an external circuit 195. The positive electrode current collector 130 is in electronic communication with a positive electroactive zone 180.

In operation, the positive electrode composition is flowed from the storage tank 100 to the electroactive zone 180 via conduit 110. The electrochemical reaction occurs at the electroactive zone. The transporting device 120 pumps the positive electrode compositions through conduits 110. Suitable transporting devices include peristaltic pumps, piston pumps, gear pumps, and gravity feed devices.

During discharge, the positive electrode composition undergoes reduction in the electroactive zone 180, and the negative electrode composition 160 undergoes oxidation. Ions flow from the negative electrode to the positive electrode through the liquid electrolyte 170 and across the ion-permeable separator 190. Electrons flow through an external circuit 195 to generate current. To recharge the system, an opposite voltage difference is applied to the battery to drive electronic current and ionic current in the opposite direction, thereby reversing the same electrochemical reactions.

The flowable electrode with elemental chalcogens and/or metal chalcogenides typically constitutes a positive electrode, which opposes a negative electrode of some other design and fabrication. Alternatively, the electrode comprising elemental chalcogens and/or metal chalcogenides electrode-active particles constitutes a negative electrode, which opposes a positive electrode of some other design and fabrication.

### Exemplary Materials and Arrangements for a Flow Battery System

To manufacture a flowable electrode according to this invention, chalcogens and/or metal chalcogenides electrode-active particles are suspended in a semi-solid fluid. Preferably, there are substantially no other electronically conductive particles suspended in the fluid. This means that the relative mass of conductive particles not containing elemental chalcogens or metal chalcogenides is less than five percent of the total combined mass of suspended particles and solutes in the fluid. The relative mass of conductive particles may in fact be less than 1 percent of the combined mass, or they may be absent entirely.

The term “semi-solid fluid” as it is used in this disclosure refers to a mixture of solid and liquid phases, such as a slurry, particle suspension, colloidal suspension, emulsion, or micelle. The term “electronically conductive particles” refers to particles that can conduct electrons, such as carbon-based particles (meso-porous carbon sphere, carbon nanotube, carbon fiber, graphene, graphene oxide, etc.), metals, metal alloys, metal oxides, metal carbides, metal nitrides and polymers.

The solid phase includes one or more elemental chalcogens, one or more metal chalcogenides, or a combination of the two as electrode-active particles. The elemental chalcogens (if present) are selected from sulfur (S), selenium (Se), tellurium (Te), typically in powder form. The metal chalcogenides (if present) generally have the formula AₓB_{y}, where A is at least one metal element, B is at least one chalcogen (S, Se, Te), x is a number between 1 and 2, and y is a number between 1 and 8. Examples of suitable metal elements include lithium (Li), sodium (Na), potassium (K), magnesium (Mg), aluminum (Al), zinc (Zn), manganese (Mn), nickel (Ni), titanium (Ti), calcium (Ca), and iron (Fe). Exemplary chalcogenides are Li₂S_{y}, Na₂S_{y}, K₂S_{y}, Li₂Se_{y}, Li₂Te_{y}, Na₂Se_{y}, and K₂Se_{y}. Other exemplary chalcogenides have the formula M₂(S₁₋ₓSeₓ)_{y} wherein 0.01≤x≤0.99, 1≤y≤8, and M is selected from Li, Na, K, Mg, and Ca.

The liquid phase is any ionically conductive liquid that can suspend and/or dissolve and transport the elemental chalcogens and/or metal chalcogenide electrode-active particles. The ionically conductive fluid is alternatively referred to in this disclosure as a liquid electrolyte. The ionically conductive liquid may be either aqueous or non-aqueous. Suitable non aqueous fluids include ethylene carbonate (EC), dimethyl carbonate (DMC), diethyl carbonate (DEC), ethylmethyl carbonate (EMC), vinyl carbonate (VC), monofluoro ethylene carbonate (FEC), ethylmethyl sulfone (EMS), tetramethylene sulfone (TMS), dimethyl sulfoxide (DMSO), adiponitrile (ADN), glutaronitrile (GLN), dimethyl methylphosphonate (DMMP), dimethyl ether (DME), diglyme, triglyme, tetraethylene glycol dimethyl ether (TEGDME), dioxolane (DOL), tetrahydrofuran (THF), and methyl-tetrahydrofuran (methyl-THF), and mixtures thereof. The ionically conductive liquid may also include a metal salt dissolved in it. Examples of suitable metal salts include lithium hexafluorophate (LiPF₆), sodium hexafluorophate (NaPF₆), potassium hexafluorophate (KPF₆), lithium perchlorate (LiClO₄), sodium perchlorate (NaClO₄), lithium nitrate (LiNO₃), bis(trifluoromethane)sulfonimide lithium salt (LiTFSI), lithium triflate (LiCFASOs), sodium triflate (NaCFASOs), lithium tetrafluoroborate (LiPFA), and sodium tetrafluoroborate (NaBFa).

The semi-solid fluid optionally includes a dispersing agent, surfactants, thickeners or binders to reduce settling of the suspended solid phases and improve suspension stability.

The negative liquid electrolyte 170 may be either aqueous or non-aqueous. Suitable non aqueous fluids include ethylene carbonate (EC), dimethyl carbonate (DMC), diethyl carbonate (DEC), ethylmethyl carbonate (EMC), vinyl carbonate (VC), monofluoro ethylene carbonate (FEC), ethylmethyl sulfone (EMS), tetramethylene sulfone (TMS), dimethyl sulfoxide (DMSO), adiponitrile (ADN), glutaronitrile (GLN), dimethyl methylphosphonate (DMMP), dimethyl ether (DME), diglyme, triglyme, tetraethylene glycol dimethyl ether (TEGDME), dioxolane (DOL), tetrahydrofuran (THF), methyl-tetrahydrofuran (methyl-THF), and mixtures of two or more of these components in any combination. Typically, the ionically conductive liquid comprises a metal salt dissolved in it. Examples of suitable metal salts include lithium hexafluorophate (LiPF₆), sodium hexafluorophate (NaPF₆), potassium hexafluorophate (KPF₆), lithium perchlorate (LiClO₄), sodium perchlorate (NaClO₄), lithium nitrate (LiNO₃), bis(trifluoromethane)sulfonimide lithium salt (LiTFSI), lithium triflate (LiCF₃SOs), sodium triflate (NaCF₃SOs), lithium tetrafluoroborate (LiPF₄), and sodium tetrafluoroborate (NaBF₄).

Current collectors 140, 130 can be electronically conductive and may be in the form of a sheet and may be made of carbon or metal include copper, aluminum, titanium or stainless steel.

The ion-permeable separator 190 can permit the transportation of ions between the positive and negative electrodes. Examples of suitable ions include O²⁻, H⁺, OH⁻, Cl⁻, Br⁻, Li⁺, Na⁺, K⁺, Ca²⁺, Mg²⁺, Al³⁺, Zn²⁺, Mn²⁺, Mn³⁺, Ti³⁺, Ti⁺, Fe²⁺, and Fe³⁺. The ion-permeable separator can be any conventional membrane that is capable of ion transport. In one or more embodiments, the separator is a porous polymer membrane infused with a liquid electrolyte that allows for the shuttling of ions between the positive and negative electrodes, while preventing the transfer of electrons or particles. The separator can be any of the solid-state ionic conductors in the form of polymer, glass-ceramic or ceramic, namely solid-state electrolytes, while preventing the transfer of electrons, liquid solvents or particles.

Exemplary ion-permeable separators are membranes made from Nafion (a sulfonated tetrafluoroethylene based fluoropolymer-copolymer), polyethyleneoxide (PEO)-based polymer electrolyte, poly(propylene carbonate) (PPC)-based polymer electrolyte, NASICON-structured solid electrolytes (Li₁₊ₓAlₓTi₂₋ₓ(PO₄)₃ (LATP) (0≤x≤0.7), Li₁₊ₓAlₓGe₂₋ₓ(PO₄)₃ (LAGP) (0≤x≤0.7), garnet-structured solid electrolytes (Li₇La₃Zr₂O₁₂), sulfide solid electrolytes (Li₂S—P₂S₅-based, Li₄₋ₓGe₁₋ₓPₓS₄), nitride solid electrolytes (Li₃N, LiPON), Na₁₊ₓZr₂SiₓP₃₋ₓO₁₂ (0≤x≤3), sodium beta-Al₂O₃, potassium beta-Al₂O₃. The static negative electrode may be an electroactive metal or a metal alloy, such as Li, Na, K, Mg, Al, and Zn.

The positive electroactive zone 180 at which the electrochemical reaction occurs. The electroactive zone may partly or fully occupy the zone between the positive electrode current collector 130 and the separator 190. The positive electroactive zone may be a porous electronic conductor, includes, but is not limited to metal foam (nickel foam, stainless foam, aluminum foam), surface-modified metal foam, carbon foam, carbon felt.

Redox Flow Batteries with Two Flowable Electrodes

FIG. 2 is a non-limiting illustration of a flow battery according to this invention with two flowable electrodes. The flow battery includes a negative electrode current collector 140 and a positive electrode current collector 130, separated by an ion-permeable separator 190. Flowable positive electrode comprising elemental chalcogens and/or metal chalcogenides electrode-active particles suspended in a semi-solid fluid without electronically conductive particles suspended in the fluid 150 are fluidly connected to a storage tank 100 via conduit 110 and a transporting device 120. The flowable negative electrode 160 are in electronic communication with a negative electrode current collector 140 and fluidly connected to a storage tank 105 via conduit 115 and a transporting device 170.

The flowable negative electrode has one or more electroactive materials dissolved or suspended in the liquid. The electroactive material may be an organic redox compound, liquid ion-storing redox composition, electroactive materials applied in the lithium, sodium, potassium or other batteries, such as amorphous carbon, disordered carbon, graphitic carbon, or a metal-coated or metal-decorated carbon, metal, metal alloy, silicon, LiCoO₂, LiFePO₄, LiMn₂O₄, LiNi_{0.5}Mn_{1.5}O₄, Li₃V₂(PO₄)₃, Li(NiₓCo_{y}Mn_{z})O₂ (x+y+z=1), and Li₄Ti₅O₁₂. A porous electronic conductor, if present, is generally made from a type of metal foam (nickel foam, stainless foam, aluminum foam), surface-modified metal foam, carbon foam or carbon felt, and is positioned between the negative current collector and the separator.

### PRACTICAL USES FOR THIS INVENTION

This invention has enormous market potential including electric vehicles industry for plug-in hybrid (PHEV) or all-electric vehicle (EV). Another important market application is to store energy from renewable energy power sources and provide electricity back to the electrical grid.

### TECHNOLOGICAL BACKGROUND

General background information on the construction and use of redox flow batteries can be found, for example, in the upcoming textbook Zhang, Li, and Zhang (2017) “Redox Flow Batteries,” CRC Press.

For additional information, the reader may refer to the following publications:
1. Chen H., Zou Q., Liang Z., Liu H., Li Q., and Lu Y. C., “Sulphur-Impregnated Flow Cathode to Enable High-Energy-Density Lithium Flow Batteries” Nature Communications, 6, Article number: 5877, (2015).
2. Cong G., Zhou Y., Li Z., and Lu Y. C., “A Highly Concentrated Catholyte Enabled by a Low-Melting-Point Ferrocene Derivative” ACS Energy Letter, 2017, 2, pp 869-875
3. Weng G. M., Li Z., Zhou Y., Cong G., and Lu Y. C., “Unlocking the capacity of iodide for high-energy-density zinc/polyiodide and lithium/polyiodide redox flow batteries” Energy & Environmental Science, 2017, 10, 735-741
4. Li Z., Weng G. M., Zou Q., Cong G., and Lu Y. C., “A High-Energy and Low-Cost Polysulfide/Iodide Redox Flow Battery” Nano Energy, 30, 283-292, 2016
5. Chen H., and Lu Y. C., “A High-Energy-Density Multiple Redox Semi-Solid-Liquid Flow Battery” Advanced Energy Materials 2016, 6, 1502183
6. Qi and Koeing (2017 May 12). “Review Article: Flow battery systems with solid electroactive materials”. Journal of Vacuum Science &Technology B, Nanotechnology and Microelectronics: Materials, Processing, Measurement, and Phenomena. 35 (4): 040801. ISSN 2166-2746. doi:10.1116, 1.4983210
7. Badwal, Giddey et al. (24 Sep. 2014). “Emerging electrochemical energy conversion and storage technologies”. Frontiers in Chemistry. 2. PMC 4174133. PMID 25309898. doi:10.3389, fchem.2014.00079
8. Alotto, Guarnieri, et al. (2014). “Redox Flow Batteries for the storage of renewable energy: a review”. Renewable & Sustainable Energy Reviews. 29: 325-335. doi:10.1016, irser.2013.08.001.

The following working examples are provided to illustrate but not to limit the assembly and use of the claimed invention.

### EXAMPLES

### Example 1: Flow Battery Using Elemental Sulfur as the Chalcogen

A flow battery has been assembled according to this invention which the schematic diagram is shown in FIG. 1. Lithium metal was used as the static negative electrode, 1 M LiTFSI in the TEGDME solvent containing 2 wt. % LiNO₃ was used as the negative liquid electrolyte. Celgard™ was used as the separator. Celgard is a porous ion-permeable separator containing polypropylene and/or polyethylene. It can be wetted by liquid electrolyte to enable transmission of ionics. The positive semi-solid electrode contained sulfur (S) powder suspended in the following liquid electrolyte: 1 M LiTFSI in TEGDME, 2 wt. % LiNO₃.

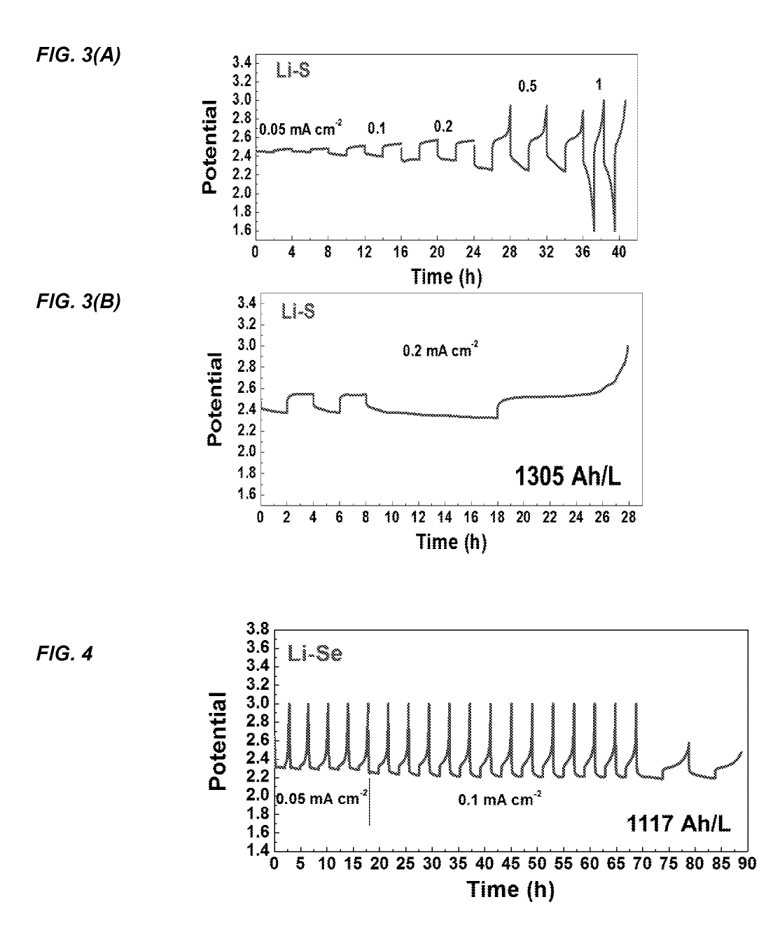

Representative plots of discharge/charge voltage of this battery as a function of time is shown in FIGS. 3A and 3B. The battery had a stable discharge/charge process.

### Example 2: Flow Battery Using Elemental Selenium as the Chalcogen

A flow battery has been assembled according to this invention which the schematic diagram is shown in FIG. 1. Lithium metal was used as the static negative electrode, 1 M LiTFSI in the TEGDME solvent containing 2 wt. % LiNO₃ was used as the negative liquid electrolyte. Celgard was used as the separator. The positive semi-solid electrode contained selenium (Se) powder suspended in the following liquid electrolyte: 1 M LiTFSI in TEGDME, 2 wt. % LiNO₃.

A representative plot of discharge/charge voltage as a function of time is shown in FIG. 4. The battery had a stable discharge/charge process.

Each and every publication and patent document cited in this disclosure is hereby incorporated herein by reference in its entirety for all purposes to the same extent as if each such publication or document was specifically and individually indicated to be incorporated herein by reference.

While the invention has been described with reference to the specific examples and illustrations, changes can be made and equivalents can be substituted to adapt to a particular context or intended use as a matter of routine development and optimization and within the purview of one of ordinary skill in the art, thereby achieving benefits of the invention without departing from the scope of what is claimed.

The invention claimed is:

1. A semisolid flowable composition configured to function as an electrode in a redox flow battery system, wherein the composition comprises:
an ionically conductive fluid; and
electrode active particles suspended in the fluid that contain one or more elemental chalcogens, one or more metal chalcogenides, or a combination thereof;
wherein the flowable composition is substantially free of any electronically conductive particles other than the chalcogens and the chalcogenides.

2. A battery cell comprising:
a positive electrode current collector;
a negative electrode current collector;
an ion permeable separator between the positive electrode collector and the negative electrode collector; and
a semisolid fluid according to claim 1 between the separator and either the positive electrode current collector or the negative electrode current collector.

3. The battery cell of claim 2, wherein the flowable composition is positioned between the positive electrode current collector and the separator, thereby configuring the flowable composition to serve as a positive electrode; and
wherein the battery cell further comprises a subsystem configured to recirculate the flowable composition between the battery cell and a reservoir.

4. A redox flow battery system comprising:
(a) a reaction region that includes:
a positive electrode current collector,
a negative electrode;
an ion permeable separator between the positive electrode collector and the negative electrode;
a flowable composition according to claim 1 between the separator and the positive electrode current collector;
wherein the flowable composition contains one or more elemental chalcogens, one or more metal chalcogenides, or a combination thereof in an ionically conductive fluid, is substantially free of any electronically conductive particles other than the chalcogens and the chalcogenides, and is configured to undergo reduction in the reaction region, thereby serving as a positive electrode for the battery system;
in combination with:
(b) a fluid circulating subsystem that includes
a reservoir containing the flowable composition;
a first conduit connecting the reservoir to the reaction region;
a second conduit connecting the reservoir to the reaction region; and
a pump;
wherein the fluid circulating subsystem is constructed and arranged so that the pump recirculates the flowable composition in the reservoir through the first conduit to the reaction region and back through the second conduit to the reservoir.

5. The battery system of claim 4, wherein the negative electrode is static, and comprises an electroactive metal or metal alloy, exemplified by lithium (Li).

6. The battery system of claim 4, wherein the negative electrode is a negative electrolytic solution or suspension positioned between the separator and a negative electrode current conductor; and
wherein the battery system further comprises a subsystem configured to recirculate a negative electrolytic solution or suspension between the reaction region and a second reservoir.

7. A redox flow battery system according to claim 4, comprising:
(a) a reaction region that includes:
a positive electrode current collector,
a negative electrode current collector an ion permeable separator between the positive electrode collector and the negative electrode collector;
said flowable composition between the separator and the positive electrode current collector; and
a negative electrolytic solution or suspension between the separator and the negative electrode current collector;
wherein the flowable composition contains one or more elemental chalcogens, one or more metal chalcogenides, or a combination thereof in an ionically conductive fluid, is substantially free of any electronically conductive particles other than the chalcogens and the chalcogenides, and is configured to undergo reduction in the reaction region, thereby serving as a positive electrode, and
wherein the negative electrolytic solution or suspension is configured to undergo oxidation in the reaction region, thereby serving as a negative electrode;
in combination with:
(b) a positive electrode fluid circulating subsystem that includes:
a first reservoir containing the flowable composition;
at least two conduits connecting the reservoir to the reaction region; and
a first pump situated to recirculate the first flowable composition between the first reservoir and the reaction region by way of the conduits; and
(c) a negative electrode fluid circulating subsystem that includes:
a second reservoir containing the negative electrolytic solution or suspension;
at least two conduits connecting the reservoir to the reaction region; and
a second pump situated to recirculate the second flowable composition between the second reservoir and the reaction region by way of the conduits.

8. A battery system of claim 4, wherein the flowable composition contains an elemental chalcogen selected from sulfur (S), selenium (Se), and tellurium (Te).

9. A battery system of claim 4, wherein the flowable composition contains a chalcogenide having the chemical formula AₓB_{y}, wherein x is either 1 or 2, y is an integer between 1 and 8, A is a metal element, and B is a chalcogen selected from sulfur (S), selenium (Se), and tellurium (Te).

10. The battery system of claim 9, wherein the chalcogenide is selected from Li₂S_{y}, Na₂S_{y}, K₂S_{y}, Li₂Se_{y}, Li₂Te_{y}, Na₂Se_{y}, and K₂Se_{y}.

11. The battery system of claim 9, wherein the chalcogenide has the formula M₂(S₁₋ₓSeₓ)_{y} wherein 0.01≤x≤0.99, 1≤y≤8, and M is Li, Na, K, Mg, or Ca.

12. The battery system of claim 4, wherein the ion permeable separator is a porous polymer membrane in the form of a polymer, glass-ceramic, or ceramic that is infused with a liquid electrolyte so as to constitute a solid-state ionic conductor,
wherein the ion-permeable separator allows for shuttling of ions between the positive and negative electrodes, while preventing transfer of electrons, liquid solvents, or particles.

13. The battery system of claim 4, wherein the ion permeable separator comprises one or more materials selected from Celgard™ (a porous separator containing polypropylene and/or polyethylene), Nafion™ (a sulfonated tetrafluoroethylene based fluoropolymer-copolymer), polyethyleneoxide (PEO)-based polymer electrolyte, poly(propylene carbonate) (PPC)-based polymer electrolyte, NASICON (sodium (Na) Super Ionic Conductor) solid electrolytes (Li₁₊ₓAlₓTi₂₋ₓPO₄)₃ (LATP) (0≤x≤0.7), Li₁₊ₓAlₓGe₂₋ₓ(PO₄)₃ (LAGP) (0≤x≤0.7), garnet-structured solid electrolytes (Li₇La₃Zr₂O₁₂), sulfide solid electrolytes (Li₂S—P₂S₅-based, Li₄₋ₓGe₁₋ₓPₓS₄), nitride solid electrolytes (Li₃N, LiPON), Na₁₊ₓZr₂SiₓP₃₋ₓO₁₂ (0≤x≤3), sodium beta-Al₂O₃, and potassium beta-Al₂O₃.

14. A battery system of claim 7, wherein the ionically conductive fluid contains one or more metal salts selected from lithium hexafluorophate (LiPF₆), sodium hexafluorophate (NaPF₆), potassium hexafluorophate (KPF₆), lithium perchlorate (LiClO₄), sodium perchlorate (NaClO₄), lithium nitrate (LiNO₃), bis(trifluoromethane)sulfonimide lithium salt (LiTFSI), lithium triflate (LiCFASOs), sodium triflate (NaCFASOs), lithium tetrafluoroborate (LiPFA), and sodium tetrafluoroborate (NaBFa).

15. The battery system of claim 7, wherein the negative electrolytic solution or suspension contains an electroactive material selected from LiCoO₂, LiFePO₄, LiMn₂O₄, LiNi_{0.5}Mn_{1.5}O₄, Li₃V₂(PO₄)₃, xLi₂MnO₃ (1-x)LiMO₂ wherein (0.01≤x≤0.99 and M is selected from Co, Ni, Mn, Fe, or Cr), Li(NiₓCo_{y}Mn_{z})O₂, Li(NiₓCo_{y}Al_{z})O₂ wherein x+y+z=1, and Li₄Ti₅O₁₂.

16. The battery system of claim 4, further comprising a separate electroactive zone between the separator and the flowable composition,
wherein the electroactive zone includes a porous material selected from nickel foam, stainless foam, aluminum foam, foam made from other metals or a combination of metals, surface-modified metal foam, carbon foam, and carbon felt.

17. The battery system of claim 4, configured such that reversal of current produced by the system will cause recharging of the system.

18. The battery system of claim 4, having an energy density of at least 1,000 W h/kg.

19. A method of powering a drivetrain in a locomotive vehicle, comprising:
completing an electrical circuit such that a redox flow battery system according to claim 4 is electrically connected to an electric motor that powers the drivetrain such that discharge of the battery system powers the drivetrain, thereby causing the vehicle to locomote.

20. A method for storing electrical power for use in an energy grid, comprising:
applying an electrical potential to a redox flow battery system according to claim 4 so as to recharge the battery system and store the electrical potential; and subsequently, alternately, or concurrently
releasing the electrical potential from the battery system into the energy grid.
